(19) United States
(12) Patent Application Publication
(10) Pub. No.: US 2008/0267437 A1
(43) Pub. Date: Oct. 30, 2008

(54) Sound transmission apparatus

(75) Inventors: Uli Gommel, Erlangen (DE); Joseph Sauer, Strullendorf (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Audiologische Technik GmbH

(21) Appl. No.: 12/150,013

(22) Filed: Apr. 24, 2008

(30) Foreign Application Priority Data
Apr. 27, 2007 (DE) 10 2007 020 056.2

(51) Int. Cl. H04R 25/00

(52) U.S. Cl. 381/324; 381/312

(57) ABSTRACT

A sound transmission apparatus that includes an outer component and an inner component, with the outer component surrounding the inner component at least partially and with at least the inner component having a through opening is provided. The sound transmission apparatus also includes a film-type component, which seals the through opening of the inner component on one side. The outer and the inner component here are connected to one another as a single piece in one working step via a multi-component injection molding method.

### CROSS REFERENCE TO RELATED APPLICATIONS

This application claims priority of German application No. 10 2007 020 056.2 DE filed Apr. 27, 2007, which is incorporated by reference herein in its entirety.

### FIELD OF INVENTION

The present invention relates to a sound transmission apparatus, in particular for hearing devices.

### BACKGROUND OF INVENTION

FIG. 1 shows a schematic illustration of a conventional hearing system 1, which includes, in a known manner, essentially a hearing device and/or microphone 2 with an on/off switch 5, a sound tube 3, which essentially forms a hearing channel and a sound transmission apparatus 4. Here, the hearing device 2 can be arranged behind an ear of a user, while the sound transmission apparatus 4 is arranged in the auditory canal.

FIG. 2 shows a detailed cross-sectional view of the sound transmission apparatus 4.

Here the sound transmission apparatus 4 includes an umbrella-type outer component 5, the so-called dome, which is to adjust itself to the anatomy of the ear, i.e. the auditory canal, and an inner component 10, the so-called C-guard, which, in conjunction with a film-type element 20, is to prevent cerumen from flowing into the sound tube 3 and/or hearing device 2 and thus disrupting the sound transmission.

In the example shown, the outer component 7 is made from silicon TPE and the inner component 10 as well as the film-type component 20 are made from harder polyethylene (PE) in comparison with silicon in each instance. The film 20 is connected to the inner component 10 by means of thermal welding.

The sound tube 3 is essentially pushed into a through opening 11 at one end 15 of the outer component 7, with the sound tube 3 abutting against a radial projection 12 arranged in the through opening 11 in order to assume a more or less defined position in respect of the sound transmission apparatus, so as to achieve certain acoustic conditions which result from the shape and arrangement of the sound tube and to avoid feedback.

The outer component 7 has openings 20, which are used on the one hand for air balancing and/or for allowing high tones to pass through, and on the other hand are to prevent a complete blockage of the auditory canal.

The outer component 7 and the inner component 10 are usually joined using an assembly device, i.e. the inner component 10 is inserted into the outer component 7. The two components here have to have a relatively high dimensional accuracy, in order on the one hand to achieve the necessary mechanical stability during insertion into the ear and removal from the ear and on the other hand to achieve the desired acoustics within the sound transmission apparatus 4.

### SUMMARY OF INVENTION

With the conventional sound transmission device, on the one hand the relatively complicated assembly is perceived to be disadvantageous and on the other hand an increased mechanical stability is perceived to be desirable.

The present invention thus addresses the object of avoiding the disadvantages of the prior art and of providing an improved sound transmission apparatus.

This object is covered by the features of the independent claims.

To this end, the invention proposes a sound transmission apparatus, including: an outer component; an inner component, with the outer component surrounding the inner component at least partially and with at least the inner component having a through opening; and a film-type component, which seals the through opening of the inner component on one side; with the outer and the inner component being connected to one another as a single piece in one working step by means of a multi-component injection molding method.

One advantage of the present invention consists in a relatively firm connection existing between the inner and outer component as a result of the type of production using a multi-component injection molding method, so that rotation and/or skewing of the two components in respect of each other is ruled out. Constant relative positions of the two components in respect of each other are particularly important since the acoustics in the hearing channel change in an unwanted fashion even with the smallest changes to said relative positions.

A further advantage consists in the production of the sound transmission apparatus being simplified by using the multi-component injection molding method, since the inner and outer components are produced in one working step. Moreover, the sound transmission apparatus can thus also be produced relatively smaller.

The outer component advantageously consists of a material which is less hard than the inner component. This is advantageous in that the outer component can adjust itself relatively effectively to the anatomy of the ear of the wearer and is also comfortable for the wearer over a longer period of time. At the same time, the relatively harder material of the inner component of the sound transmission apparatus overall imparts an effective rigidity. Silicon is the preferred material for the outer component and polyethylene is the preferred material for the inner component and for the film-type component in each instance, with the film-type component preferably being connected to the inner component by means of thermal welding.

It is also preferred if the through opening has connecting means, which are suited to connecting the sound transmission apparatus in a defined manner to an external hearing apparatus. In this way, the connecting means can include for instance at least one thread or a type of bayonet fastening in order thus to connect the sound transmission apparatus to the sound tube in a simple and defined manner. On the one hand this prevents the sound tube from being unintentionally separated from the sound transmission apparatus, when the sound transmission apparatus is being removed from the auditory canal of the ear. On the other hand it ensures that the acoustics of the hearing system are not impaired as a result of the defined connection of the sound transmission apparatus to the sound tube.

### BRIEF DESCRIPTION OF THE DRAWINGS

The invention is described in more detail below with reference to the figures, in which;

FIG. 1 shows a schematic view of a conventional hearing system with a sound transmission apparatus;

FIG. 2 shows a detailed cross-sectional view of the conventional sound transmission apparatus from FIG. 1 and

FIG. 3 shows an inventive sound transmission apparatus.

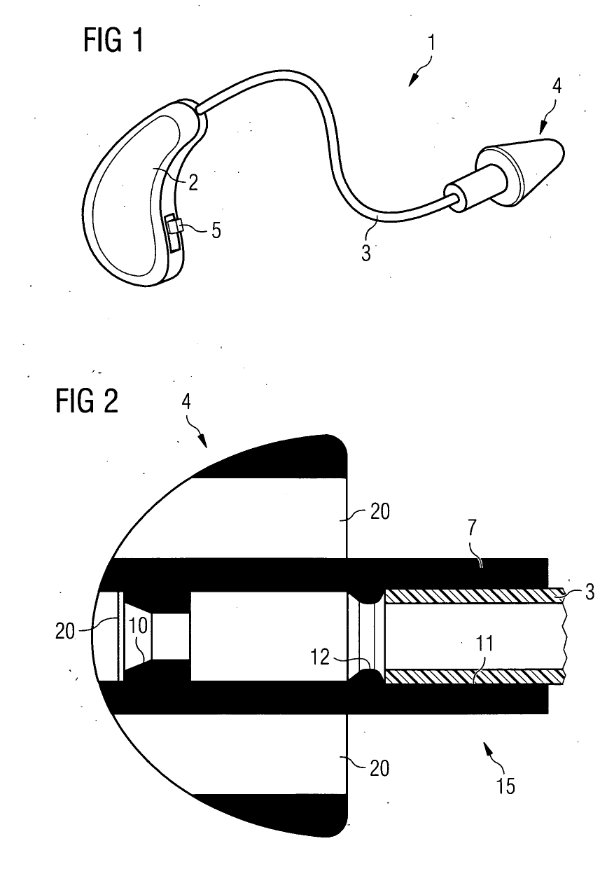

### DETAILED DESCRIPTION OF INVENTION

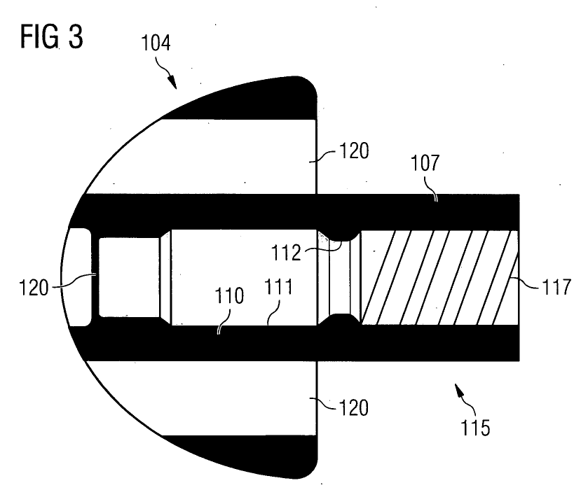

FIG. 3 shows a sound transmission apparatus 104 in accordance with the present invention. Here the sound transmission apparatus 104 includes an outer component 107 and an inner component 110, which are produced by means of a two component injection molding method in one working step and thus form a single unit composed of two different material components. In the example shown, the outer component 107 consists of relatively soft silicon, while the inner component 110 consists of relatively hard polyethylene. However, other suitable material components are also conceivable, whereby it should be noted that the outer component consists of a softer material than the inner component, since the outer component is to adjust itself effectively to the auditory canal anatomy.

In the exemplary embodiment in FIG. 3, the outer component 107 completely covers the inner component 110; it is however also conceivable for the outer component 107 to only cover the inner component 110 in parts.

The form of the sound transmission apparatus 104 essentially corresponds to the form of the sound transmission apparatus 4 shown in FIG. 2, i.e. the outer component 107 has openings 120, which are used on the one hand for air balancing and/or for allowing high tones to pass through and are on the other hand to prevent a complete blockage of the auditory canal.

Furthermore, the inner component 110 has a through opening 111, which, as part of the hearing channel, is used to transmit sound, which is emitted from a hearing device via a sound tube (not shown here). A suitable sound tube is inserted into the through opening 111 at one end 115 of the sound transmission apparatus 104 and is fixed in a defined manner in respect of the inner component 110 by means of a thread 117. Instead of a thread 117, a bayonet fastening is also conceivable for instance, in order to produce a more secure and defined connection between a sound tube and the sound transmission apparatus 104. A radial projection 112 in the through opening 11 is used here as a stop for a sound tube.

The through opening 111 is sealed by a film 120 opposite the end 115. As described above, this is to prevent cerumen from penetrating the hearing channel and thus impairing the function of the entire hearing system.

In the example shown, the film 120 is embodied as a single piece with the inner component 110. It is however also conceivable for the film to be connected to the inner component 110 by means of thermal welding, laser welding or adhesion for instance.

1.-6. (canceled)

7. A sound transmission apparatus, comprising:
an inner component having a through opening and a film-type component sealing the through opening of the inner component on one side; and
an outer component at least partially surrounding the inner component, the outer component having at least one opening, the outer and the inner components being connected to one another as a single piece in one working step via a multi-component injection molding.

8. The sound transmission apparatus as claimed in claim 7, wherein the outer component is made from a material which is less hard than the inner component.

9. The sound transmission apparatus as claimed in claim 8, wherein the outer component is made from silicon and the inner component being made from polyethylene.

10. The sound transmission apparatus as claimed in claims 7, wherein the film-type component is made from polyethylene and is connected to the inner component via thermal welding, laser welding or adhesion.

11. The sound transmission apparatus as claimed in claims 7, wherein with the through opening having connector for connecting the sound transmission apparatus to an external hearing apparatus in a defined manner.

12. The sound transmission apparatus as claimed in claims 11, wherein the connector means includes at least one thread.

13. A sound transmission apparatus, comprising:
an inner component having a through opening and a film-type component sealing the through opening of the inner component on one side; and
an outer component at least partially surrounding the inner component, the outer component having at least one opening for a purpose selected from the group consisting of air balancing, allowing high tones to pass through, to prevent a complete blockage of the auditory canal and combinations thereof,
wherein the outer component is made from a material which is less hard than the inner component.

14. The sound transmission apparatus as claimed in claim 13, wherein the outer component is made from silicon and the inner component being made from polyethylene.

15. The sound transmission apparatus as claimed in claims 13, wherein the film-type component is made from polyethylene and is connected to the inner component via thermal welding, laser welding or adhesion.

16. The sound transmission apparatus as claimed in claims 13, wherein with the through opening having connector for connecting the sound transmission apparatus to an external hearing apparatus in a defined manner.

17. The sound transmission apparatus as claimed in claims 16, wherein the connector means includes at least one thread.
